(19) United States
(12) Patent Application Publication
(10) Pub. No.: US 2012/0305672 A1
(43) Pub. Date: Dec. 6, 2012

(54) INTEGRATED PNEUMATIC SPRAY DEVICE

(76) Inventor: Xinggang Pan, Wenling City (CN)

(21) Appl. No.: 13/233,921

(22) Filed: Sep. 15, 2011

(30) Foreign Application Priority Data
May 30, 2011 (CN) 201120176129.X

(51) Int. Cl. B05B 9/01

(52) U.S. Cl. 239/526

(57) ABSTRACT

An integrated pneumatic spray gun includes a gun body and a paint tank installed on the gun body. A feeding port of the paint tank is communicated with a chute in the gun body. The gun body is further provided with an integrated electric air pump. An air opening of the air pump is communicated with an air passage of the gun body. The gun body, the paint tank and the air pump form an integrated structure. In the pneumatic spray gun of the present invention, the air pump is installed on the gun body, and no air pipe needs to be used for connection, which is convenient to operate and saves the costs.

### CROSS-REFERENCE TO RELATED APPLICATION

This non-provisional application claims priority to and the benefit of, pursuant to 35 U.S.C. §119(a), Patent Application No. 201120176129.X filed in China on May 30, 2011, the entire content of which is hereby incorporated by reference.

### FIELD OF THE INVENTION

The present invention relates generally to a spray device, and more particularly, to integrated pneumatic spray device.

### BACKGROUND OF THE INVENTION

In the related art, a pneumatic spray gun generally includes a gun body and a paint tank that connects with the gun body, and needs a pressure provided by an external electric air pump or an air source in other forms. The air pump and the gun body are connected by an air pipe. Therefore, in practice, the length of the air pipe needs to be set in accordance with the using distance. However, the air pipe may be stiff and difficult to pull around in use, which is inconvenient for use. Also, the length of the air pipe needs to be adjusted in accordance with different uses and environments, which may increase the costs.

### SUMMARY OF THE INVENTION

To overcome the defects existing in the related art, in one aspect, the present invention is directed to an integrated pneumatic spray gun which is convenient for use and does not need to use any air pipe.

In one aspect, the integrated pneumatic spray gun of the present invention includes a gun body and a paint tank installed on the gun body. A feeding port of the paint tank is communicated with a chute in the gun body. The gun body is further provided with an integrated electric air pump. An air opening of the air pump is communicated with an air passage of the gun body. The gun body, the paint tank and the air pump form an integrated structure.

In another aspect, the integrated pneumatic spray gun of the present invention further has the following technical features.

The air pump includes a housing, a motor installed in the housing and a pump driven by the motor, the housing is provided with an air passage connector, and the connector is communicated with the pump.

An air passage port is arranged at a top of a rear end of the gun body and the air pump is installed at the air passage port.

The air passage port is provided with a lid, the lid is formed with a port, and the connector is inserted in the port.

An engagement block is formed on an inner wall of the port, a rotary engagement slot is formed on an outer wall of the connector, and the engagement block is retained in the engagement slot.

The connector is provided with a baffle plate.

The housing is provided with a power switch.

A paint tank port is arranged at a front end of the gun body and a reinforcing board is disposed between the paint tank port and a handle.

The lid is fixed at the air passage port by a screw.

At least two engagement blocks are formed and the number of the engagement slots is identical to that of the engagement blocks.

The integrated pneumatic spray gun of the present invention in comparison with the related art has the following advantages. First, in the pneumatic spray gun of the present invention, the air pump is installed on the gun body, and no air pipe needs to be used for connection, which provides the convenience in use and reduces the costs. Secondly, the air pump of the present invention has an integrated structure and is installed on the gun body by a buckle structure, which provides the convenience of replacement.

### BRIEF DESCRIPTION OF THE DRAWINGS

FIG. 1 is a front view of one embodiment of the present invention;

FIG. 2 is a three-dimensional view of the embodiment of the present invention;

FIG. 3 is a cross-sectional view of the embodiment of the present invention;

FIG. 4 is an exploded three-dimensional view of the embodiment of the present invention; and

FIG. 5 is an exploded three-dimensional view of the embodiment of the present invention from another angle of view.

### DETAILED DESCRIPTION OF THE INVENTION

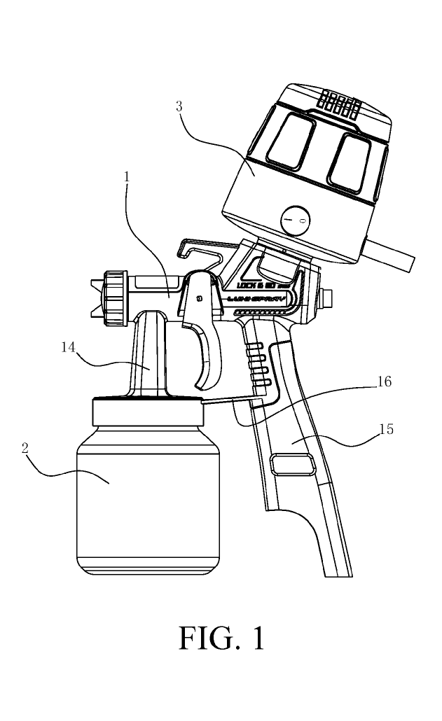

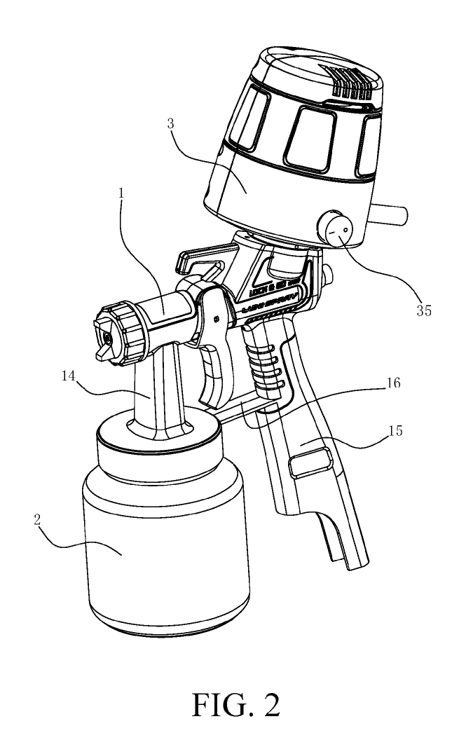

Referring to FIG. 1 and FIG. 2, an integrated pneumatic spray gun according to an embodiment of the present invention includes a gun body 1 and a paint tank 2 installed on the gun body 1. A feeding port of the paint tank 2 is communicated with a chute in the gun body 1. The gun body 1 is further provided with an integrated electric air pump 3. An air opening of the air pump 3 is communicated with an air passage of the gun body 1. The gun body 1, the paint tank 2 and the air pump 3 form an integrated structure. The integrated electric air pump 3 of the present invention refers to an integrated structure of a motor and an air pump, which may be used as a unity. The motor and the air pump may both adopt the mature products, and the detailed structure and working principle will not be described herein. The present invention directly installs this structure on the gun body 1, so that the gun body 1, the paint tank 2 and the air pump 3 form an integrated structure. In use, no air pipe needs to be used and only a power connection wire is required. The power connection wire may be plugged in a regular receptacle and the consideration of the length is not needed, so the equipment is convenient to operate and saves the costs.

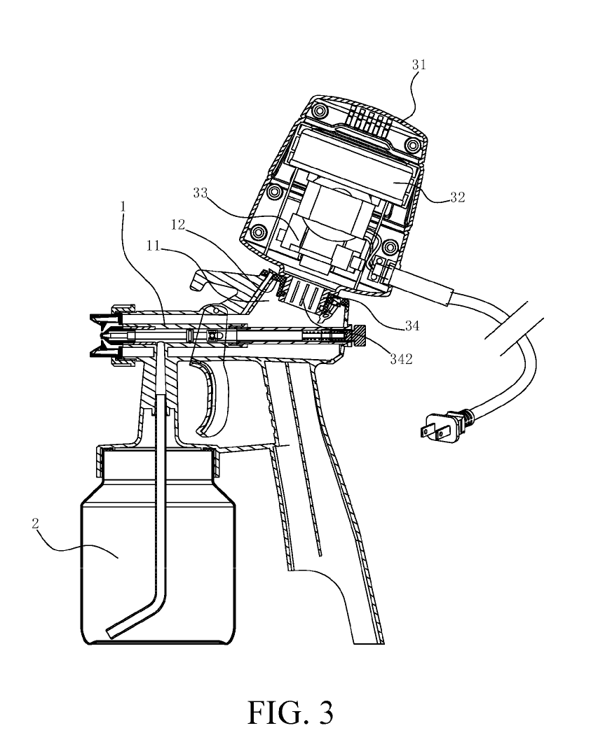

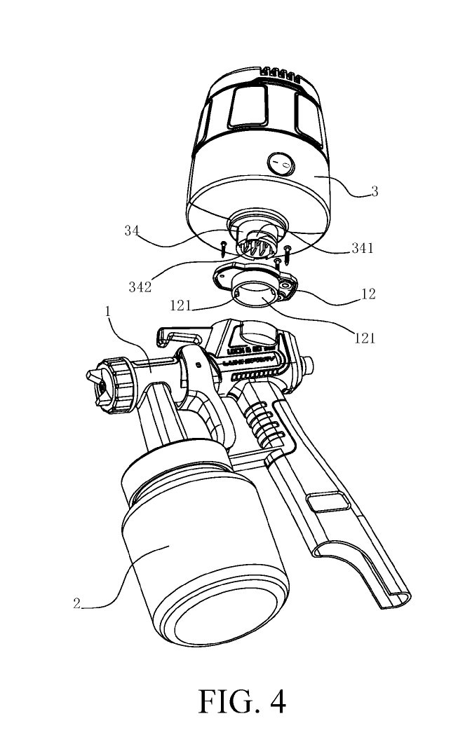

Referring to FIG. 3 to FIG. 5, in the above embodiment of the present invention, the air pump 3 includes a housing 31, a motor 32 installed in the housing 31 and a pump 33 driven by the motor 32. The housing 31 is provided with an air passage connector 34. The connector 34 is communicated with the pump 33. In the present invention, the motor 32 and the pump 33 are installed in one housing 31 to form an integrated structure, and are then connected to the gun body 1 by the connector 34. The air pump 3 in this form may be fabricated to be small and light for the convenience of operation.

Referring to FIG. 3 to FIG. 5, in the above embodiment of the present invention, an air passage port 11 is arranged at a top of a rear end of the gun body 1, and the air pump 3 is installed at the air passage port 11. The air passage port 11 is located at a top of a handle and when in use, the weight of the air pump 3 directly falls in the hands, so the present invention is convenient to operate.

Referring to FIG. 3 to FIG. 5, in the above embodiment of the present invention, the air passage port 11 is provided with a lid 12, the lid 12 is formed with a port 121, and the connector 34 is inserted in the port 121. An engagement block 122 is formed on an inner wall of the port 121, a rotary engagement slot 341 is formed on an outer wall of the connector 34, and the engagement block 122 is retained in the engagement slot 341. In the present invention, the air pump 3 and the gun body 1 are connected by a buckle structure, so that the air pump 3 is convenient to be assembled or disassembled and is convenient to operate.

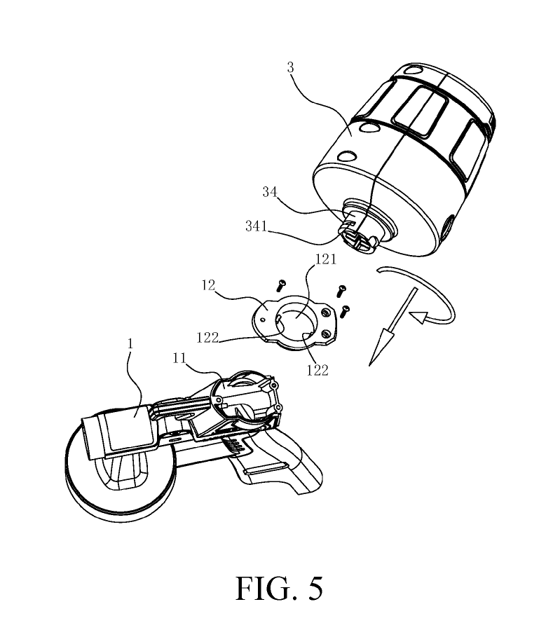

Referring to FIG. 3 and FIG. 5, in the above embodiment of the present invention, the lid 12 is fixed at the air passage port 11 by a screw. The lid 12 is convenient to fabricate and as the lid 12 is installed on the gun body 1, the fabrication and installation are convenient.

Referring to FIG. 3 to FIG. 5, in the above embodiment of the present invention, at least two engagement blocks 122 are formed, and the number of the engagement slots 341 is identical to that of the engagement blocks 122. In this embodiment, the number is two, and alternatively may also be three or four. The engagement block 122 is corresponding to the engagement slot 341. The rotary engagement slot refers to that the engagement slot has a vertical entry and a transverse slot. The engagement block enters from the entry and after rotated, the engagement block enters the slot, thus achieving the connection. When detaching, the above processes are carried out in a reverse order.

Referring to FIG. 3 to FIG. 5, in the above embodiment of the present invention, the connector 34 is provided with a baffle plate 342. The baffle plate 342 guides an air flow to facilitate the air flow to enter the gun body and produce a pressure.

Referring to FIG. 1 and FIG. 2, in the above embodiment of the present invention, the housing 31 is provided with a power switch 35. The power switch 35 controls the operation of the motor.

Referring to FIG. 2 and FIG. 3, in the above embodiment of the present invention, a paint tank port 14 is arranged at a front end of the gun body 1, and a reinforcing board 16 is arranged between the paint tank port 14 and the handle 15. The reinforcing board 16 provides a reinforcing function.

While there has been shown several and alternate embodiments of the present invention, it is to be understood that certain changes can be made as would be known to one skilled in the art without departing from the underlying scope of the present invention as is discussed and set forth above and below including claims. Furthermore, the embodiments described above and claims set forth below are only intended to illustrate the principles of the present invention and are not intended to limit the scope of the present invention to the disclosed elements.

What is claimed is:

1. An integrated pneumatic spray gun, comprising:
a gun body and a paint tank installed on the gun body, wherein a feeding port of the paint tank is communicated with a chute in the gun body, the gun body is further provided with an integrated electric air pump, an air opening of the air pump is communicated with an air passage of the gun body, and the gun body, the paint tank and the air pump form an integrated structure.

2. The integrated pneumatic spray gun according to claim 1, wherein the air pump comprises a housing, a motor installed in the housing and a pump driven by the motor, the housing is provided with an air passage connector, and the connector is communicated with the pump.

3. The integrated pneumatic spray gun according to claim 2, wherein an air passage port is arranged at a top of a rear end of the gun body and the air pump is installed at the air passage port.

4. The integrated pneumatic spray gun according to claim 3, wherein the air passage port is provided with a lid, the lid is formed with a port, and the connector is inserted in the port.

5. The integrated pneumatic spray gun according to claim 4, wherein an engagement block is formed on an inner wall of the port, a rotary engagement slot is formed on an outer wall of the connector, and the engagement block is retained in the engagement slot.

6. The integrated pneumatic spray gun according to claim 2, wherein the connector is provided with a baffle plate.

7. The integrated pneumatic spray gun according to claim 2, wherein the housing is provided with a power switch.

8. The integrated pneumatic spray gun according to claim 1, wherein a paint tank port is arranged at a front end of the gun body and a reinforcing board is disposed between the paint tank port and a handle.

9. The integrated pneumatic spray gun according to claim 4, wherein the lid is fixed at the air passage port by a screw.

10. The integrated pneumatic spray gun according to claim 5, wherein at least two engagement blocks are formed and the number of the engagement slots is identical to that of the engagement blocks.
